(19) United States
(12) Patent Application Publication
(10) Pub. No.: US 2018/0244243 A1
(43) Pub. Date: Aug. 30, 2018

(54) ASSEMBLY FOR MOTOR VEHICLE EQUIPMENT AND ASSOCIATED MOTOR VEHICLE

(71) Applicant: Valeo Systèmes d'Essuyage, Le Mesnil Saint Denis (FR)

(72) Inventor: Anne Sanon, Le Mesnil Saint Denis (FR)

(73) Assignee: Valeo Systèmes d'Essuyage, Le Mesnil Saint Denis (FR)

(21) Appl. No.: 15/903,491

(22) Filed: Feb. 23, 2018

(30) Foreign Application Priority Data
Feb. 28, 2017 (FR) 1751599

(51) Int. Cl. B60S 1/04

(52) U.S. Cl. CPC B60S 1/0427; B60S 1/583; B60S 1/0438; B60S 1/0444

(57) ABSTRACT

The present invention relates to an assembly (111) for motor vehicle equipment comprising:
an electric motor (3),
a fixing plate (11) to which the electric motor (3) is fixed at least at one attachment point (14), the said fixing plate (11) comprising:
at least one fixing point (20) intended for the fixing of the fixing plate (11) to an element external to the assembly (111), such as a structural element of the vehicle,
   in which the fixing plate (11) has at least one slot (25) associated with the fixing point (20) and distinct from the associated fixing point (20), the said at least one slot (25) extending over at least part of the thickness of the fixing plate (11).

The present invention relates to the field of motor vehicle equipment comprising an electric motor and, more specifically, assemblies intended for fixing the electric motors of such equipment using a fixing plate.

Fixing plates are intended to hold electric motors and fix them to other elements of the vehicle such as, for example, a structural element of the vehicle or another element of the wiper system. The electric motors of the equipment are generally protected by housings which comprise plates which may serve as fixing plates or alternatively the housing may be fixed to an intermediate fixing plate. In some cases, the housing may also protect other elements of the equipment. For example, in wiper equipment, the electric motor may be coupled to reduction gearing and the housing protects both the electric motor and the reduction gearing.

The fixing plate, which forms or does not form part of the housing, is made of metal and/or of plastic and is generally fixed to a structural element of the vehicle using retaining screws.

One problem associated with motor vehicle equipment comprising an electric motor has to do with the vibration this equipment can produce. Specifically, the acoustics and absence of vibration have been found to be some of the essential comfort factors in present day motor vehicles which means that it has become necessary to prevent or, at the very least, attenuate the transmission of the vibration produced by an electric motor to the other elements of the vehicle and particularly to the vehicle interior.

Thus, it is known practice to use shock-absorbing pads positioned at the interface between the equipment comprising an electric motor and the structure of the vehicle, namely at the level of the fixing plate, in order to obtain mechanical decoupling and to attenuate the vibration produced by the electric motor.

However, it may be that the reduction in vibration afforded by the shock-absorbing pads is insufficient compared with the desired amount of reduction or that it is desirable to dispense with shock-absorbing pads, notably to make it easier to mount the equipment in the vehicle.

In order to at least partially overcome these disadvantages, the present invention relates to an assembly for motor vehicle equipment comprising:
an electric motor,
a fixing plate, to which the electric motor is fixed at least at one attachment point, and intended to support the electric motor, the said fixing plate comprising:
   at least one fixing point intended for the fixing of the fixing plate to an element external to the assembly, such as a structural element of the vehicle,
   at least one slot associated with the fixing point and distinct from the associated fixing point, the said at least one slot extending over at least part of the thickness of the fixing plate.

The use of at least one slot associated with a fixing point makes it possible to improve the vibrational decoupling between the electric motor and the external element, and this is something that may potentially make it possible to dispense with shock-absorbing pads at the interface between the fixing plate and the external element. This then makes it possible to improve the attenuation of the vibration produced by the electric motor of the equipment.

According to another aspect of the present invention, the fixing point comprises an opening made in the fixing plate.

According to an additional aspect of the present invention, at least one slot is positioned between the fixing point and the attachment point and extends substantially perpendicular to a direction connecting the said fixing point to the said attachment point.

According to an additional aspect of the present invention, the at least one slot is formed inside a predefined perimeter around the fixing point.

According to another aspect of the present invention, the perimeter is comprised within a radius of 3 cm around the fixing point, in particular between 1 mm and 3 cm.

According to an additional aspect of the present invention, the at least one slot extends around the fixing point.

According to an additional aspect of the present invention, the at least one slot describes an arc of a circle or a circle around the fixing point.

According to another aspect of the present invention, the assembly comprises at least a first series of slots which are arranged at a first radius from the fixing point and a second series of slots which are arranged at a second radius from the centre of the fixing point distinct from the first radius, the slots of the first series being at least partially angularly offset from the slots of the second series.

According to an additional aspect of the present invention, the at least one slot is a through-slot.

According to an additional aspect of the present invention, the width of the at least one slot is comprised between 1 and 10 mm.

According to another aspect of the present invention, the fixing plate is made of a laminated composite material comprising a plurality of layers at least one of the layers of which is made from a viscoelastic material.

The use of a laminated composite material with a layer of viscoelastic material makes it possible to attenuate the transmission of vibration through the plate. Such a material may be combined with the use of slots to attenuate even further the vibration transmitted by the fixing plate.

According to an additional aspect of the present invention, the assembly comprises a geared motor unit of a wiper equipment.

The present invention also relates to a motor vehicle comprising an assembly as described hereinabove.

Further features and advantages of the invention will become apparent from the following description given by way of nonlimiting example with reference to the attached drawings in which:

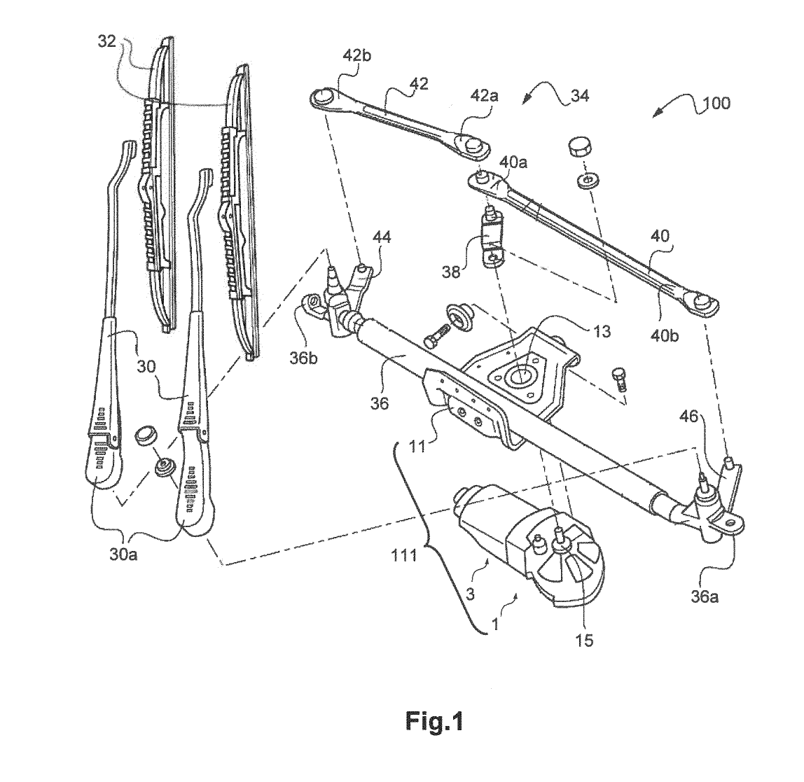

FIG. 1 depicts an exploded view of motor vehicle wiper equipment;

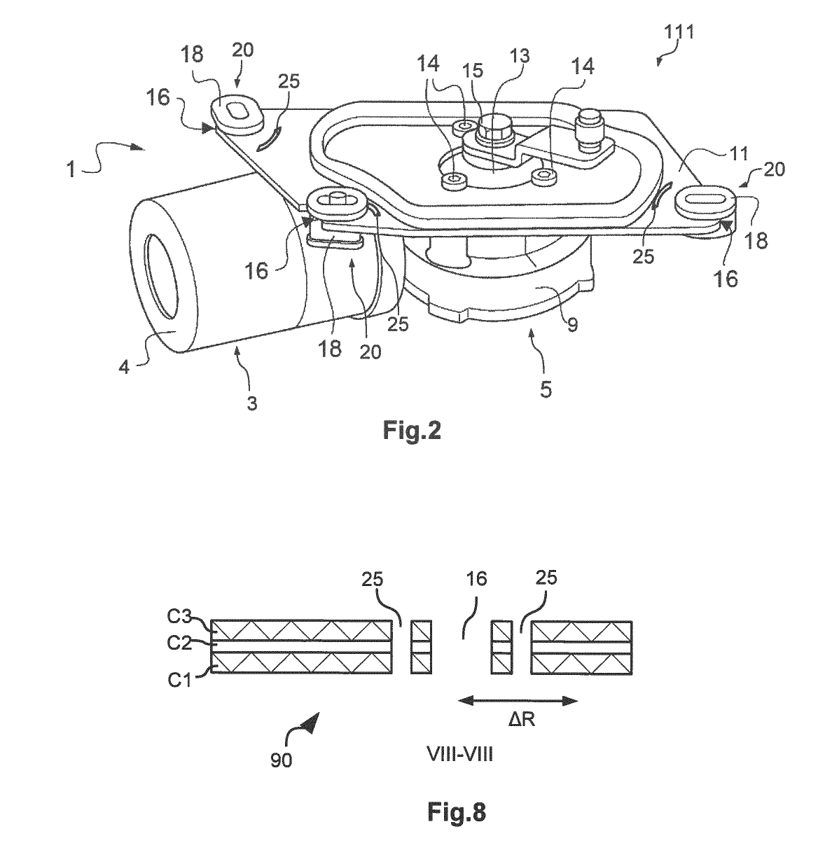

FIG. 2 depicts an assembly for motor vehicle equipment according to the present invention;

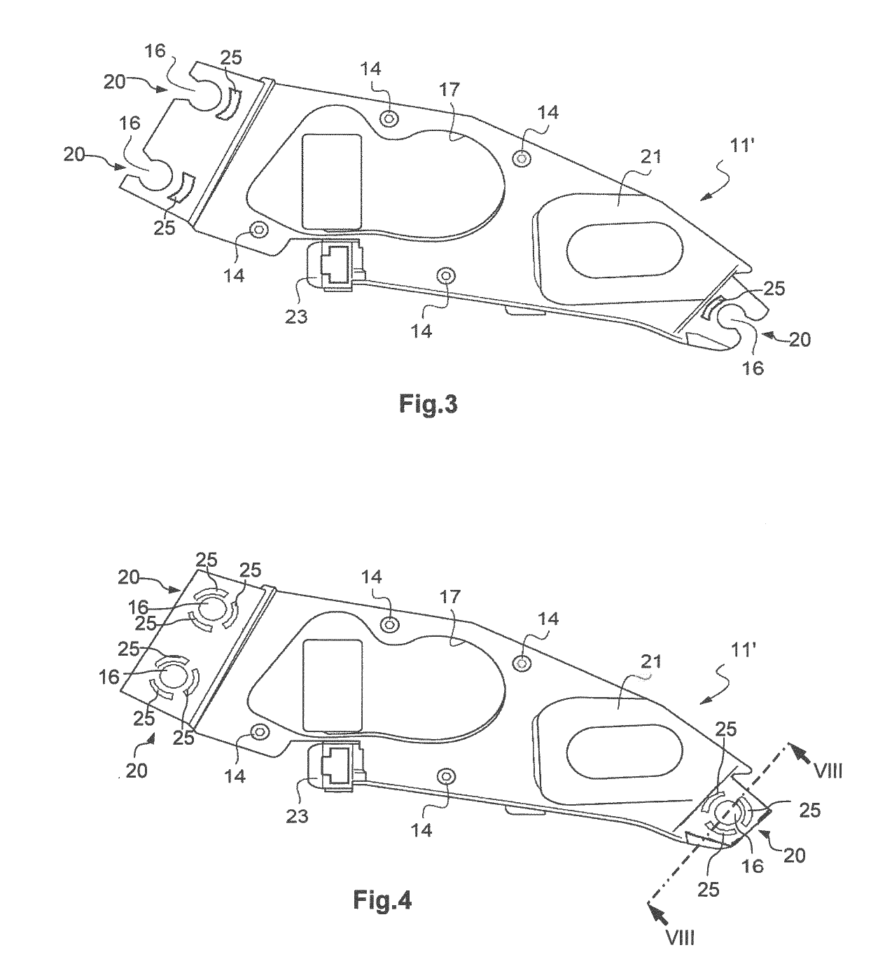

FIGS. 3 to 6 depict a diagram of a fixing plate for an assembly according to the present invention with various configurations of openings and slots made in the plate;

FIGS. 7a and 7b depict various configurations regarding the slots made in the plate;

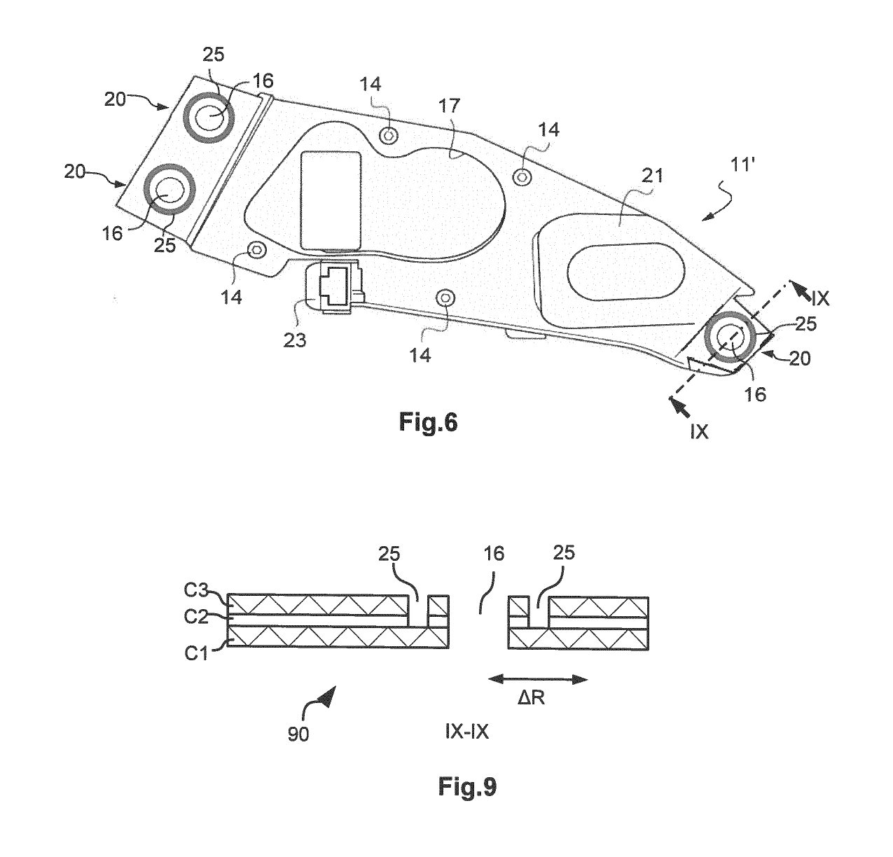

FIGS. 8 and 9 are views in section on VIII-VIII and IX-IX of the fixing plates of FIGS. 4 and 6.

In all the figures, elements that have identical functions bear the same reference numerals.

In the remainder of the description, the term “opening”, particularly associated with a plate, refers to a mechanical interface obtained by an absence of material such as, for example, a hole made in the plate or a notch, notably of half-moon shape, formed on an edge of the plate.

The term “fixing plate” associated with an electric motor assembly refers to any element that has a thickness that is smaller than its other dimensions and allows elements of the assembly comprising the electric motor to be fixed to an element external to the assembly such as a structural element of the vehicle. Thus, the fixing plate may be used simply for fixing or may also act as a protective housing protecting the electric motor or other elements of the assembly. The fixing plate is not necessarily flat.

The following embodiments are examples. Although the description refers to one or more embodiments, that does not necessarily mean that each reference relates to the same embodiment or that the features apply only to one single embodiment. Single features of various embodiments can also be combined or interchanged to form other embodiments.

The present invention applies to all motor vehicle equipment comprising an electric motor. In the remainder of the description, a wiper equipment will be described by way of example, although the invention is not restricted to that type of equipment.

FIG. 1 depicts an exploded view of a wiper equipment 100 comprising an electric motor 3. In the example illustrated, the electric motor 3 and a reduction gear mechanism to which it is connected form a geared motor unit 1. The equipment 100 also comprises wiper arms 30 at the ends of which wipers 32 are mounted in an articulated manner, and a linkage 34 allowing the movement of the output shaft 15 of the geared motor unit 1 to be transmitted to the wiper arms 30 to drive the pivoting of the wiper arms 30. The linkage 34 for example connects the two wiper arms 30 situated on the windscreen at the front of the vehicle to the geared motor unit 1 for driving the back and forth sweep of the driver-side and passenger-side wipers 32. To do that, the linkage 34 comprises by way of elements: a support tube 36, a motor output lever 38, also referred to as “crank”, two link rods 40, 42 of which a “master” link rod on the driver side and a “slave” link rod on the passenger side, and two arm big-end levers 44, 46 mounted with the ability to rotate on the ends of the support tube 36.

A first end of the motor output lever 38 is fixed to the output shaft 15 of the geared motor unit 1, for example with a “tight” fit. A second end of the motor output lever 38 is articulated to first ends 40a, 42a of the link rods 40, 42, for example using two “ball-cup” fittings. Second ends 40b. 42b of the link rods 40, 42 are articulated to first ends of a respective arm big-end lever 44, 46, for example via a respective “ball-cup” fitting. Second ends of the arm big-end levers 44, 46 are fixed to a respective big end 30a of a wiper arm 3, for example by screwing.

In operation, rotation of the output shaft 15 of the geared motor unit 1 causes the motor output lever 38 to pivot about the axis of the output shaft 15. The motor output lever 38 causes the link rods 40, 42 to move and these make the arm big-end levers 44, 46 pivot about their respective second ends to drive the pivoting of the wipers 32.

The wiper equipment 100 also comprises a fixing plate 11 configured to hold the geared motor unit 1 and possibly the support tube 36. The fixing plate 11 is intended to be fixed, directly or otherwise, to a structural element of the vehicle. The support tube 36 may also be fixed to a structural element at its end fittings 36a and 36b. Alternatively, the fixing plate 11 may be fixed to the support tube 36, the geared motor unit 1 then being fixed to the fixing plate 11. In that case, the support tube 36 is fixed to a structural element of the vehicle, for example via its end fittings 36a and 36b.

FIG. 2 depicts a first embodiment of an assembly 111 comprising an electric motor 3 and a fixing plate 11 to which the electric motor is fixed at three attachment points 14. The electric motor 3, housed in a casing 4 in this instance of cylindrical shape, forms for example part of a geared motor unit 1 similar to the geared motor unit 1 shown in FIG. 1 but also containing a reduction gear mechanism 5 connected to the electric motor 3. The geared motor unit 1 also comprises a base 9 in which there is formed a space intended to house the reduction gear mechanism 5. The base 9 and the casing 4 of the electric motor 3 are mechanically fixed to one another, for example using screws or by welding or by any fixing means known to those skilled in the art. In one alternative form, the base 9 and the casing 4 are of one piece.

For certain types of geared motor unit 1, for example in the case of a rear screen wiper system, the base 9 may also accept a built-in connecting rod-crank system.

The fixing plate 11 is, in the example illustrated, intended to be fixed on the one hand to the base 9 and on the other hand to an element external to the assembly 111, notably a passive element, namely a structural element of the vehicle or an element that is fixed with respect to the structure of the vehicle, such as, for example, the tailgate of the vehicle in the case of a rear screen wiper or an element of the linkage 34 fixed to the structure of the vehicle.

In the example illustrated, the fixing plate 11 is fixed to the base 9 at least at one attachment point 14, or, in the case of FIG. 2, at three attachment points 14 embodied by three screws 14. Other types of attachment point may also be used to fix the electric motor 3 to the fixing plate 11.

The fixing plate 11 may have varying forms according to the model of electric motor 3, of geared motor unit 1, and according to the shape of the external element to which it is fixed, notably a flat and rectangular shape in the present instance. The fixing plate 11 may also comprise an orifice 13, in this instance a central orifice, through which the output shaft 15 of the geared motor unit 1 extends.

The fixing plate 11 also comprises fixing points 20, three in this instance, so that it can be fixed to an element external to the assembly 111, notably a passive element. In this instance, the fixing points 20 comprise openings 16 intended to accept screws. The openings 16 are, for example, situated on the periphery of the fixing plate 11 and may be produced in the form of holes or notches of various shapes, for example of half-moon shape.

However, the location and number of the fixing points 20 may vary according to the shape of the fixing plate 11 and to the shape of the external element to which the fixing plate 11 is fixed.

The means of fixing the fixing plate 11 to a passive element may also comprise shock-absorbing pads 18 positioned at the interface between the fixing plate 11 and the external element in order to filter vibration.

The fixing plate 11 also comprises at least one slot 25 associated with a fixing point 20, in this instance represented as an opening 16. The slot 25 associated with a fixing point 20 is arranged in such a way as to attenuate chiefly vibration spreading via the associated fixing point 20. As a preference, at least one slot 25 will be associated with each opening 16.

In the case of FIG. 2, the fixing plate 11 comprises three slots 25 respectively associated with the three openings 16. The slots 25 have an elongate overall shape. The slots 25 are formed near the associated opening 16, for example within a perimeter ΔR, in the example of 3 cm, around the fixing point 20, namely around the opening 16 depicted in FIGS. 7a, 7b , 8 and 9. The slots 25 are distinct from the opening 16. In addition, the slots 25 extend around the opening 16 in such a way as to attenuate the spread of vibration between the electric motor 3 and the external element on which the fixing plate 11 is fixed.

As a preference, at least one slot 25 is positioned between the fixing point 20 and the point(s) 14 of attachment of the electric motor 3 to the fixing plate 11 that correspond(s) to the location of the screws 14 in the case of FIG. 2. In addition, the slots 25 are formed in such a way as to form a discontinuity in the fixing plate 11 between the screws 14 and the fixing points 20, in this instance the openings 16, and extend in the fixing plate 11 towards the fixing screws 14. At least one of the slots 25 therefore extends roughly perpendicular to the direction connecting the associated opening 16 and the fixing screws 14. The slots 25 are depicted here as having a curved shape but other shapes, notably rectilinear shapes, may also be used. Other configurations of openings 16 and of associated slots 25 will be described later on in the description.

FIG. 3 depicts a fixing plate according to a second embodiment. In this example, the fixing plate 11′ closes the space in the base 9 that houses the reduction gear mechanism 5 and therefore acts as a casing for the reduction gear mechanism 5. This fixing plate 11′ has an elongate shape and comprises a first recess 17 corresponding to the place for the reduction gear mechanism 5, a second recess 21 corresponding to the place for the electric motor 3 and a connector 23 for providing the electrical connection for the geared motor unit 1, for example to a control circuit of the vehicle. The screws 14, of which there are four, allow the base 9 to be fixed to the fixing plate 11′, the base 9 and the casing 4 of the electric motor 3 notably being mechanically fixed to one another.

The fixing plate 11′ comprises at least one fixing point 20, three in the current instance, indicated by the openings 16 that allow the fixing plate 11′ to be fixed to a structural element of the vehicle. The openings 16 in this instance have the form of notches. Two openings 16 are positioned at a first end of the fixing plate 11 and the third opening is positioned at a second end of the fixing plate 11′.

However, other shapes of fixing plate 11′ and/or other locations for the openings 16 may be envisaged. The fixing means for the fixing plate 11′ are the same as the fixing means for the fixing plate 11 described hereinabove with reference to FIG. 2. In addition, the fixing plate 11′ also comprises three slots 25 associated with the three fixing points 17, the layout of the slots 25 being similar to the layout of the slots 25 of the fixing plate 11 of FIG. 2, namely between the associated opening 16 and the attachment points 14 comprising for example the fixing screws.

FIGS. 2 and 3 depict notch-shaped openings 16 and a slot 25 associated with each opening 16 for two types of fixing plates 11, 11′ of different shapes. However, the present invention is not restricted to the two shapes depicted but extends to any shape of fixing plate.

In the remainder of the description, various configurations of openings 16 and of slots 25 will be described on the basis of just one type of fixing plate although all the configurations that will be described can be applied to both types of fixing plate 11 and 11′ introduced hereinabove and to other types of fixing plate that will allow an electric motor 3 to be fixed to an external element, particularly a passive element such as a structural element of the vehicle.

Various configurations of openings 16 and of slots 25 will now be described with reference to FIGS. 4 to 9.

FIGS. 4, 5 and 6 depict a fixing plate 11′ which differs from the fixing plate 11′ of FIG. 3 in terms of the openings 16 and of the slots 25.

The fixing plate 11′ of FIG. 4 has three openings 16 in the form of holes with a closed contour and three slots 25 associated with each opening 16. The slots 25 have the shape of an arc of a circle and are distributed about the associated opening 16 in such a way as to surround the associated opening 16 over a large proportion of its circumference in a great many directions.

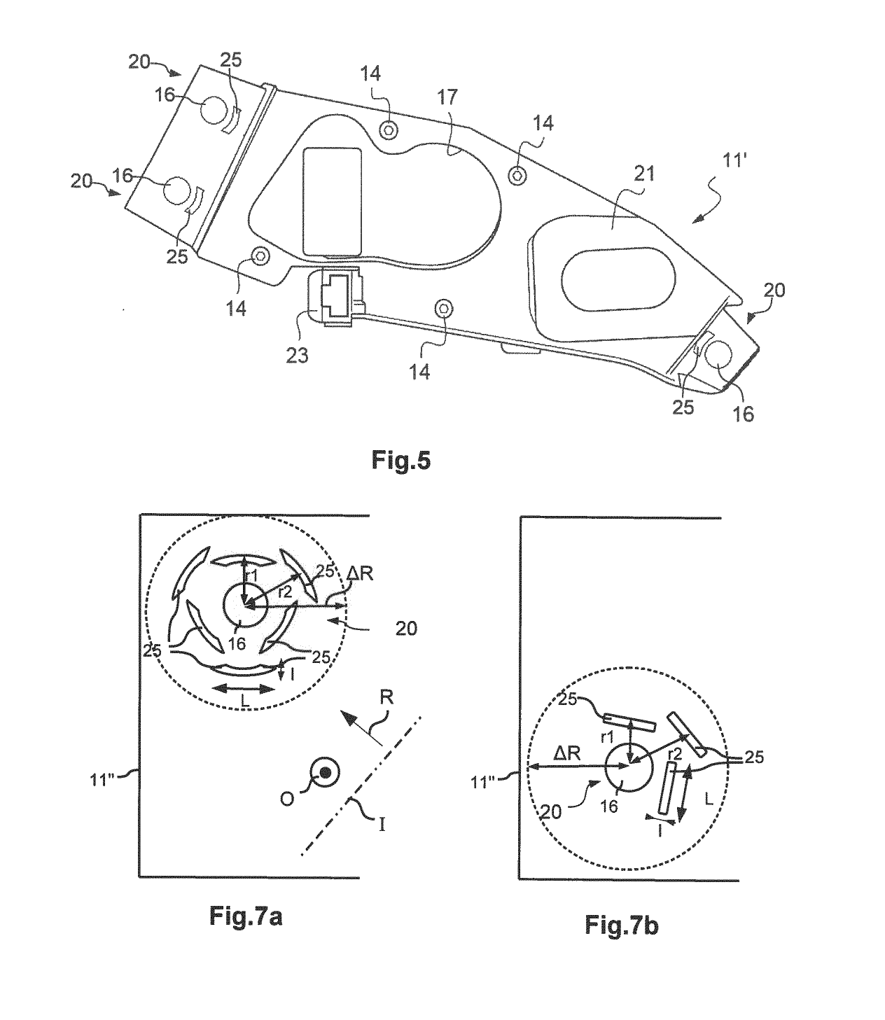

The fixing plate 11′ of FIG. 5 has three through-openings 16 of closed contour and a slot associated with each opening 16. The slots 25 are formed between the associated opening 16 and the fixing screws 14 corresponding to the fixing of the base supporting the reduction gear mechanism 5 and the electric motor 3.

It should be noted that the shape of the slots 25 is not necessarily curved, for example as an arc of a circle, but may for example be rectilinear.

In addition, the slots 25 associated with an opening 16 do not necessarily extend around the entire contour of the opening 16 but may be limited to one side of the opening 16 as depicted in FIGS. 3 and 5.

The slots 25 preferably extend in a direction substantially perpendicular to the direction connecting the associated opening 16 to the fixing for fixing the electric motor 3 to the fixing plate 11, 11′.

The fixing plate 11′ in FIG. 6 has three openings 16 in the form of holes with a closed circular contour and a slot 25 associated with each opening 16. The slots 25 are formed all around the openings 16. In this case, the slots 25 are formed on just part of the thickness of the fixing plate 11′, as depicted in FIG. 9 which depicts a view in cross section along the axis of section IX-IX of FIG. 6.

FIG. 9 depicts a view in cross section of a laminated plate 90 corresponding to the fixing plate 11′ of FIG. 6 but such a laminated plate 90 can also be used for the other embodiments of fixing plate 11 or 11′.

The laminated plate 90 illustrated comprises three layers denoted C1, C2 and C3.

One of the layers, notably the layer C2, may be made from a viscoelastic material making it possible to obtain vibrational decoupling and to attenuate the noise emitted by the geared motor unit 1.

At least one of the layers, for example the layer C1, may be a metallic layer so as to form a barrier against electromagnetic waves and improve electromagnetic compatibility between the assembly 111 comprising the electric motor 3 and the other elements of the vehicle. The layers C1 and C3 may be formed from the same material or from a different material and the thicknesses of the layers may be the same or different.

The laminated plate 90 comprises an opening 16 in the form of a through-hole and a slot 25 formed around the opening 16; the slot 25 is formed only in the layers C2 and C3 but could also be formed only in the layer C3 (alternatively only in the layers C1 and C2 or only in the layer C1). The fact that the slot 25 is formed in only certain layers of the laminated plate 90 means that an annular slot in the shape of a circle can be created right the way around the hole 16 as depicted in FIG. 6.

Alternatively, when the slot or slots are formed over just part of the contour of the opening 16, as depicted for example in FIG. 3 or 4, the slot 25 may be formed through the entire thickness of the fixing plate 11c. FIG. 8 corresponds to a view in cross section along the axis of section VIII-VIII of FIG. 4. FIG. 8 depicts a laminated plate 90 corresponding to the fixing plate 11′, but which could also correspond to a fixing plate 11, comprising three layers denoted C1, C2 and C3 similar to the previously-described layers of FIG. 9.

Thus, the slots 25 may be through-slots (except in the case of an annular slot as depicted in FIG. 6) or may be confined to part of the thickness of the fixing plate 11, 11′. In particular, if the fixing plate 11, 11′ is a laminated plate 90 comprising several layers, the slots 25 may be formed through just certain layers. In addition, as depicted in FIGS. 8 and 9, the slots are formed within a perimeter ΔR around the openings 16.

Slots 25 may also be formed at different distances around the opening 16 as depicted in FIGS. 7a and 7b. The fixing plate 11″ depicted in FIGS. 7a and 7b may correspond to a fixing plate 11 or 11′ as described in the present application.

The width of the slots 25, denoted l, is comprised for example between 1 and 10 mm and the length of the slots 25, denoted L, is comprised for example between 1 and 3 cm. The width l may be uniform or may vary along the slot 25.

FIG. 7a depicts part of a fixing plate 11″ comprising an opening 16 and a first configuration of slots 25 associated with the opening 16.

This first configuration comprises a first series of three slots 25 distributed around the opening 16 which series is arranged at a first radius r1 from the centre of the opening 16 and a second series of slots 25 distributed around the opening 16 which series is arranged at a second radius r2 greater than the first radius r1. The radii r1 and r2 are comprised within the perimeter ΔR around the opening 16.

In addition, the slots 25 of the first series are angularly offset from the slots 25 of the second series so as to be distributed all around the opening 16. The slots have a curved shape in the form of arcs of a circle but other shapes, notably rectilinear, may also be used.

FIG. 7b depicts a fixing plate 11″ comprising an opening 16 and a second configuration of slots 25 which are associated with an opening 16. In this second configuration, the opening 16 is associated with three rectilinear slots 25, two slots 25 situated at a first radius r1 and a third slot 25 situated at a second radius r2 and the slots 25 are situated over only a certain portion around the opening 16. The slots 25 are also angularly offset from one another to cover a significant angle around the opening 16. The dimensions of the slots 25 are similar to those described for the slots 25 of FIG. 7a and are also comprised within the perimeter ΔR around the opening 16.

Furthermore, in the various embodiments set out hereinabove, the features (number, size, shape, etc.) of the slots 25 and notably the orientation thereof may be adapted according to the position of the axis of rotation of the electric motor 3. To do that, advantageously, slots are at least partially oriented radially and orthoradially with respect to the axis of rotation of the electric motor 3. The axis of rotation 1 of the motor 3 is depicted schematically as a broken line in FIG. 7a, The radial and orthoradial directions are indicated respectively by the arrows R and O. Thus, in order to limit the transmission of vibration produced by the electric motor 3, slots 25 are placed in the radial and/or orthoradial directions of the axis of rotation 1. In the case of FIG. 7a, slots 25 are placed in the radial direction R between the axis of rotation 1 and the opening 16.

The various features of the slots 25 given in the various figures can be combined, for example a plurality of rectilinear slots 25 may be associated with a notch-shaped opening 16, rectilinear and curvilinear slots may be associated with the one same opening 16. Other shapes of slots 25, for example sawtooth or wavy slots, may also be used as may other shapes of openings 16, for example oblong, such that the present invention is not restricted to the shape of the openings 16 and of the slots 25 which are depicted in the figures.

In general, the position, the number and the size (width l and length L) of the slots 25 are determined in such a way as to attenuate vibration between the electric motor 3 and the external element such as, for example, the structural element to which the fixing plate 11, 11′, 11″ is fixed while at the same time limiting as far as possible the loss of stiffness of the fixing plate 11, 11′, 11″.

The use of slots 25 to attenuate the transmission of vibration does not necessarily require the use of shock-absorbing pads at the fixing means for fixing the fixing plate 11, 11′, 11″ to the external element such as, for example, a structural element of the vehicle, which means that the use of shock-absorbing pads is optional.

The use of slots 25 around the fixing points 20 used for fixing the fixing plate 11, 11′, 11″ providing the connection between an assembly comprising an electric motor 3 and the rest of the vehicle therefore makes it possible to attenuate the transmission of the vibration emitted by the electric motor 3 towards the rest of the vehicle and thus contributes to improving the overall comfort of the users of the vehicle without the need for additional equipment and therefore without generating additional cost. The use of slots can be coupled with the use of a laminated composite plate and/or of shock-absorbing pads or on its own to improve the filtration of the vibration transmitted between the electric motor and the rest of the vehicle.

1. The assembly for motor vehicle equipment comprising:
an electric motor; and
a fixing plate to which the electric motor is fixed at least at one attachment point, the fixing plate comprising:
at least one fixing point intended for the fixing of the fixing plate to a structural element of the vehicle that is external to the assembly, and
at least one slot associated with the fixing point and distinct from the associated fixing point, the at least one slot extending over at least part of the thickness of the fixing plate.

2. The assembly according to claim 1, in which the fixing point comprises an opening made in the fixing plate.

3. The assembly according to claim 1, in which at least one slot is positioned between the fixing point and the at least one attachment point and extends substantially perpendicular to a direction connecting the fixing point to the attachment point.

4. The assembly according to claim 1, in which the at least one slot is formed in a predefined perimeter around the fixing point.

5. The assembly according to claim 4, in which the perimeter is comprised within a radius of 3 cm around the fixing point.

6. The assembly according to claim 4, in which the at least one slot extends around the fixing point.

7. The assembly according to claim 6, in which the at least one slot describes an arc of a circle or a circle around the fixing point.

8. The assembly according to claim 6, further comprising at least a first series of slots which are arranged at a first radius from the fixing point and a second series of slots which are arranged at a second radius from the centre of the fixing point distinct from the first radius, the slots of the first series being at least partially angularly offset from the slots of the second series.

9. The assembly according to claim 1, in which the at least one slot is a through-slot.

10. The assembly according to claim 1, in which the width of the at least one slot is comprised between 1 and 10 mm.

11. The assembly according to claim 1, in which the fixing plate is made of a laminated composite material comprising a plurality of layers at least one of the layers of which is made from a viscoelastic material.

12. The assembly according to claim 1, comprising a geared motor unit of a wiper equipment.

13. A motor vehicle comprising an assembly according to claim 1.
